(19) United States
(12) Patent Application Publication
(10) Pub. No.: US 2018/0060847 A1
(43) Pub. Date: Mar. 1, 2018

(54) SELF-SERVICE ELECTRONIC FULFILLMENT METHOD FOR LICENSED RAFFLES

(71) Applicants: Paul Burch, Regina (CA); Jody Price, Regina (CA); Jared Donauer, Blackfalds (CA)

(72) Inventors: Paul Burch, Regina (CA); Jody Price, Regina (CA); Jared Donauer, Blackfalds (CA)

(21) Appl. No.: 15/270,532

(22) Filed: Sep. 20, 2016

(30) Foreign Application Priority Data
Aug. 30, 2016 (CA) 2940441

(51) Int. Cl. G06Q 20/18; G06Q 30/06; G06Q 20/40

(52) U.S. Cl. CPC G06Q 20/18; G06Q 20/4014; G06Q 30/0601

(57) ABSTRACT

A method of self-serve electronic ticket sales to purchasors in a plurality of licensed raffles which can replace traditional paper-based raffle methods. A server contains a raffle database including a. plurality of raffle records corresponding to raffles offered for sale, including limitations of who can buy tickets in the raffle to comply with license requirements. Purchasors access the server via their client devices to review the details of available raffles for sale which are selected and displayed to the purchasor by comparison of the purchasor's profile with raffle criteria, and can purchase tickets in the raffles directly through the session between their device and the server. The vendor of the raffle is not required to use purpose built hardware to facilitate ticket sales, and regulatory compliance is ensured by requiring the details of a license to be stored in respect of each raffle in order for it to be offered for sale.

### CLAIM OF PRIORITY

This application claims priority to Canadian patent application 2,940,441 filed on Aug. 30, 2016, 0 the contents of which are herein fully incorporated by reference in its entirety.

### FIELD OF THE EMBODIMENTS

This invention is in the field of lotteries and raffles, such as charitable 50/50 draws and the like, and electronic systems for the sale of tickets in such raffles. More specifically the invention provides a self-serve system by which a purchasor can buy a ticket in one or more raffles through a self-serve website interface—and only available raffles for which the purchasor is qualified will be presented for sale.

### BACKGROUND OF THE EMBODIMENTS

Lotteries and raffles are gaming concepts that are used in many contexts, to provide profit opportunities or fundraising for the sponsors of such raffles or draws. Varying types of these games have been available for many years, firstly using paper based systems and ticket books—for example raffles, 50-50 tickets and the like which are sold at events or in a longer timeframe. Traditional paper-based systems of offering these games however were labor-intensive and could also result in complicated infrastructure and significant waste of printed ticket products dependent upon the outcome of a particular raffle or game. Paper-based ticketing in these types of contests is still quite popular however, in part because the alternatives typically involve the deployment of large amounts of purpose built or expensive hardware. If it were possible to provide an alternative method to the sales of tickets and lotteries and raffles, to paper-based ticket sales, it is believed that this would be well received by parties in this industry.

As the popularity of raffles has increased there has been some innovation and development in the creation and deployment of electronic ticketing and administration systems for use with these types of raffles. These can often be seen at professional or college sporting events, festivals, fairs, fundraising dinners, etc. As outlined above, the expense of the use of such hardware and ticketing systems limits the adoption or use of raffles such as this for fundraising purposes by charitable organizations and others since they cannot afford the cost of the hardware.

The use of an electronic system to sell and issue the tickets and administer the necessary data to allow for the conduct of such a raffle or draw provides for the ability to sell the tickets in larger volume at a rapid pace. It allows for less possibility of human error or cash leakage in the vending of tickets since there are fewer volunteers or human intervention required in the process. If it were possible to minimize the amount of hardware required however or to find an alternate means of providing an electronically facilitated ticket sale method, it is known that this would be widely accepted in the industry.

Many of the prior art methods of ticket sales in these types of lotteries are raffles involve the use of handheld raffle sales units which are connected to a central server. The operator of the raffle sales unit then takes the money or processes payment for tickets purchased at a particular event and issues the tickets sold from the raffle sales unit. In addition to the expense of the raffle sales units which is one limiting factor to the widescale adoption of electronic sales methods for raffles such as that disclosed, the current methods that are available also are by virtue of the use of this hardware to a degree limited in terms of the location where the sales can be conducted. They typically require a network connection between the raffle sales unit and the server which may require proprietary or closed networking hardware, in addition to requiring trained and likely paid operators of the raffle sales units. These types of approaches will still retain their attraction in certain venue based sales methods, but it is believed that if it were possible to eliminate the need for the use of a raffle sales terminal or hardware, with an operator, significant market opportunity could be created for various entities seeking to sell raffle tickets or the like for fundraising purposes.

Another limitation to many prior art methods is that a vendor of a particular bearer raffle or lottery will typically only sell tickets in that particular lottery or raffle. There may be an opportunity to enhance sales of tickets in multiple lotteries are raffles if it were possible to easily provide the ability for a purchasor of tickets to buy tickets in more than one available raffle at the same time. One of the limitations however would be that only raffles for which a particular purchasor was qualified to purchase tickets could be presented for that purpose—for example raffles which are being sold in a particular geographic area, in a particular time frame or the like. If it were possible to provide an electronically facilitated lottery ticket sales method which allowed for the presentation of only available raffles to a purchasor for consideration and ticket sale, minimizing the amount of hardware required to facilitate electronic transaction of the sale, it is believed that this would again be a beneficial function which would be industrially received with favor.

One additional limitation to lotteries and raffles is that by and large in most jurisdictions they need to be sold with licenses, or with strict adherence to regulations. If it were possible to provide an electronic system for the sale of tickets in multiple raffles or lotteries which would automatically enforce license requirements upon the vendor this would also be an enhancement which would be, it is thought, well received not only by vendors but also by regulatory authorities.

Based upon the current state of the art in this area, it is considered that finding a way to provide for electronically facilitated “self-serve” ticket sales method for use in the sale of tickets in lotteries and raffles, which would facilitate the sales of such tickets to ticket purchasors directly without the need for third-party sales personnel or hardware to be used, and which would in all cases indicate to the purchasor of the tickets the regulatory compliance of the lottery or lotteries in question, would be a desirable system for development, representing a novel creation over the current state of the art and a significant commercial opportunity.

### SUMMARY OF THE EMBODIMENTS

The present invention comprises a system and method for the self-serve sale of tickets in licensed raffles to purchasors. The method of self-serve electronic ticket sales to purchasors in a plurality of licensed raffles of the present invention comprises a plurality of steps—the first of which is providing a raffle server which is operatively connected to a communications network for communication with at least one client device of a purchasor. The raffle server contains a ticketing server software component which is capable of serving and facilitating raffle ticket sales to at least one client device of a purchasor.

The raffle server contains or is operatively connected to a purchasor database which is comprised of a plurality of purchasor records, each of which purchasor records corresponds to a retail purchasor of raffle tickets and includes identifying particulars of the purchasor as well as any raffle qualification criteria of the purchasor, being criteria used to determine the qualification of the purchasor to buy tickets in particular raffles. In addition to the purchasor database, the raffle server is also operatively connected to or hosts a raffle database comprising a plurality of raffle records. Each raffle record corresponds to a raffle offered for sale by a vendor and includes ticket price information as well as a defined time period within which tickets in the raffle can be sold, details of a license applicable to the raffle and any raffle availability criteria, being criteria which must be met by purchasors in order to purchase tickets in the raffle. Additionally, the raffle server is also operatively connected to a ticket database which comprises a plurality of ticket records, each ticket record corresponding to a ticket sold in a raffle in accordance with the system and method of the present invention comprising ticket parameters of the tickets sold, a link to the raffle record for the raffle in respect of which the ticket was sold, and a link to the purchasor record of the purchase through her who purchased the ticket.

The raffle server is also operatively connected to a payment gateway via which the raffle server can process electronic payments for the purchase of tickets.

The method of selling tickets in a raffle to at least one purchasor is accomplished by, in respect of each ticket sale, allowing the purchasor having a purchase record, via the user interface of a client device, to authenticate themselves to the raffle server and subsequently receive and view via the user interface of the client device the details of any available raffles. Available raffles are any raffles for which the defined time period remains open for ticket sales, and for which the raffle qualification criteria of the purchasers satisfy the raffle availability criteria of the raffle.

The purchasor can purchase at least one ticket in the at least one available raffle via the user interface of the client device by selecting at least one of the raffles in respect of which a ticket purchase is desired, selecting the purchase details for the tickets to be purchased and entering electronic payment details in respect of the ticket purchase. The selected and entered purchase details will be transmitted to the raffle server, including the raffle record identifier, purchasor record identifier and electronic payment details of each ticket sale to the raffle server, in a purchase transmission.

Upon the receipt of a purchase transmission by the raffle server, payment for the tickets to be purchased will be processed by the payment gateway using the transmitted electronic payment details contained within the purchase transmission, and a ticket record will be created within the ticket database corresponding to each ticket sold for each raffle in question. Notification of the purchase and completion of the ticket sale can be provided back to the purchasor via their client device.

Following the expiry of the defined time period for a raffle, the plurality of ticket records corresponding to the raffle will be extracted from the ticket database and at least one winning ticket can be selected there from and identified to the vendor and/or the purchasor of the ticket or tickets in question. The details of the at least one winning ticket will be transmitted to the vendor of the raffle, and the monetary proceeds of the raffle will be settled to the vendor. Each raffle record must contain details of an applicable license, to verify its legality and compliance with lottery sales) regulations, and the ticket sales transactions all take place directly between the raffle server and a purchasor through their client device, without in team any intermediate sales entities are hardware etc.

As will be understood, the primary system which is contemplated is a client/server website type system, where the raffle server is a Web server, the communications network is the Internet, and the at least one client device comprises a web client with a browser software capable of communication with the ticketing server software component on the reference server.

The raffle database can contain raffle records corresponding to raffles operated by one or more vendors. In a service bureau approach, operating a raffle database in the system which contains raffle records and facilitates the sales of raffles of more than one vendor is contemplated to maximize the economic efficiency of raffle ticket sales operations, particularly for example for nonprofit operators and the like of such raffles.

As outlined above, each raffle which will be administered by the system and method of the present invention must be licensed, as it is contemplated that in most cases raffle ticket sales are a regulated process which require regulatory and legal compliance. Requiring that a vendor include details of the license of the raffle in the raffle records such that those can be provided to potential ticket purchasers and otherwise used in reporting and other compliance activities is an important element of the system and method herein. The vendor could either have pre-purchased a license or prearranged a license for the raffle and the system could allow for the entry of the raffle license details into the system in respect of the raffle record in question as the raffle record was created, or the ticketing server software can also facilitate the sales or assignment of licenses to raffles—the ticketing server software can assign a license to a raffle in the creation of a raffle record by contacting a license issuing server with the details of the raffle and the vendor, and receiving the details of an issued license for storage in the raffle record. In other cases, it may also be the case that if the system and method of the present invention were operated as a service bureau per se, where raffles of more than one vendor were operated on the system, sonic regulatory regimes might permit the sharing of a group license at the server level, wherein the ticketing server software could assign a license on the creation of a raffle record by allowing the raffle record to share a group license held by the operator of the server, the details of which would be stored to the raffle record. While the importance of the storage of license information with respect to each raffle and its corresponding raffle record is outlined as a key dement of the method of the present invention, it will be understood that there are many different ways that licenses for raffles could be procured or reported to the database and any number of different types of license details or methods of storage of license details in respect of the raffle records in the raffle database are contemplated within the scope of the present invention.

As outlined above, a logical closing step to the sale of a ticket in a raffle in accordance with the remainder of the method would be to provide details of the ticket sale to the client device and the purchasor, such as a receipt for the ticket number details etc. That can be done in many different communications methods and any type of an approach in which the details of the ticket sale are provided to the client device and the purchasor are contemplated within the scope of the present invention.

It is specifically contemplated that one of the key commercial benefits of the service bureau approach of the system of the present invention, where the raffle database may contain raffle records corresponding to raffles operated by more than one vendor, is that purchasors could purchase tickets in more than one available raffle, operated by one or more different vendors, in the same purchase transaction. Rather than just simplifying or shifting the sales channel for an existing raffle, the consumer audience for tickets in a particular raffle could be broadened, since the system within appropriate parameters could present the opportunity to purchase tickets in additional raffles to purchasors when they went on the system to purchase a ticket in a particular raffle or raffles.

It is likely that purchasor records in the purchasor database would either need to be created by a manual interface via a client device by the purchasor in advance of one or more purchases, or in certain cases information captured in the sale of a ticket can be used to pre-populate a purchasor record for future use. In any event, the ticketing server software component would include in many embodiments the ability to facilitate the creation and maintenance of purchasor records and the purchasor database by a purchasor from their client device.

Similar to providing the ability to create purchasor records, the system and method of the present invention and the ticketing server software component and the raffle server could also include or provide the ability to facilitate the creation and maintenance of raffle records in the raffle database by operators of raffles from a client device. Again there are many different types of interfaces or approaches which could be contemplated with respect to this aspect of the method and all such approaches as would be obvious to those skilled in the art of database and software interface design and the like are contemplated within the scope of the present invention.

Basically in operation of the method of the present invention, a ticket purchasor could use a client device to interface with the raffle server and create, or authenticate themselves in respect of a pre-existing, purchasor record. Based on the raffle qualifying criteria contained within the purchasor record, or which is entered to create the purchasor record, the ticketing server software component could present to the purchasor via the user interface of the client device a list of available raffles in which they can purchase tickets at that particular time. The user could select one or more raffles, operated by one or more operators or vendors, via the interface of their device and transmit a sales request along with electronic payment details back to the server, where the purchase of the tickets could be electronically facilitated, and ticket records created in the ticket database in respect of each ticket sale in each raffle. Following the closure of a particular raffle sales window, the system can automatically choose one or more winning tickets from the ticket records in the ticket database corresponding to sales in respect of that raffle and the closing fulfillment or payout in the raffle, both to the vendor as well as to the winner or winners, could be completed or facilitated.

In addition to the method of self-serve sales of tickets in these types of raffles to purchasors, the method requires a specific type of a raffle server. The raffle server itself and its design is also contemplated within the scope hereof. The raffle server would be capable of communicating with at least one client device via a communications network, and comprises at least a processor, a memory storing a ticketing server software component capable of serving and facilitating raffle ticket sales to at least one client device; a purchasor database comprising a plurality of purchasor records each of which corresponds to a retail purchasor of raffle tickets and include identifying particulars of the purchasor and any raffle qualification criteria of the purchasor, being criteria used to determine the qualification of the purchasor to buy tickets in particular raffles. The memory also contains a raffle database comprising a plurality of raffle records each corresponding to a raffle offered for sale by vendor and including ticket pricing information as well as a defined time period within which tickets in the raffle can be sold, details of the license applicable to the raffle and any raffle availability criteria, being matching criteria against which purchasors will be compared in order to ascertain their compatibility or availability to purchase tickets in the raffle. The memory also includes a ticket database comprising a plurality of ticket records, each ticket record corresponding to ticket sold in a raffle and comprising ticket parameters of the tickets sold, a link to the radical record of the raffle and a link to the purchasor record of the purchasor.

The raffle server also includes a payment gateway, which could be a resident computer software or hardware component, or a communications interface of some kind to an external gateway, via which the raffle server can process electronic payments for ticket sales.

The raffle server will be used to facilitate ticket sales in a method wherein in respect of each ticket sale to a purchasor with a client device, the ticketing server software component on the server will facilitate the steps of authenticating the purchasor by the client device; serving to the user interface of the client device the details of any available raffles, available raffles being any raffles for which the defined time period remains open and for which the raffle qualification criteria of the purchasor satisfy the raffle availability criteria of the raffle; allowing the purchasor to purchase at least one ticket in at least one available raffle via the user interface of the client device by selecting at least one available raffle in respect of which a ticket purchase is desired, selecting the purchase details for the tickets to be purchased in the at least one available raffle selected, and entering electronic payment details in respect of the ticket purchase. In respect of a ticket purchase the server software would then facilitate the transmission of the selected and entered purchase details and electronic payment details including a raffle record identifier, the purchasor record identifier and electronic payment details of each ticket sale back to the raffle server in a purchase transmission. On receipt of a purchase transmission from a client device, the server would facilitate the processing of payment from the purchasor for the tickets to be purchased by the payment gateway, using the captured electronic payment details contained within the purchase transmission, and upon successful payment processing create a ticket record within the ticket that is corresponding to each ticket sold in each available raffle.

Following the expiry of the defined time period for a raffle, the server would extract the ticket records corresponding to the raffle in question from the ticket database and select at least one winning ticket therefrom, and transmit the details of the at least one winning ticket to the vendor along with settling the monetary proceeds of the raffle to the vendor and the at least one winner either directly or by facilitating the calculations for payment out of those amounts through third parties or other channels. Each raffle record in the raffle database would contain details of the applicable license to that raffle, and the ticket sales transactions each take place directly between the server and the purchasor without any intermediate sales entities.

As outlined above, with respect to the method of the present invention, the raffle server which is explicitly contemplated is a Web server, with the communications network being the Internet and the at least one client device comprising web browser capable client devices capable of communicating with the ticketing server software component. It will be understood by those skilled in the art of software and hardware network design that other topologies, architectures and server and system types could also be contemplated which would allow for the development of a system that would accomplish the same objectives outlined herein and all such modifications as would be obvious to those skilled in the art are also contemplated to be within the scope of the present invention.

The raffle server is explicitly contemplated to be of great utility in the operation of a “service bureau”, where the raffle database contains raffle records corresponding to raffles operated by more than one vendor.

In addition to facilitating the actual ticket sales, the raffles server of the present invention can also facilitate the assignment of raffle licenses to raffles in the system as raffle records were created or maintained within the raffle database. The ticketing server software component can assign a license to a raffle in the creation of a raffle record by contacting a license issuing server with the details of the raffle and the vendor, and receiving the details of an issued license for storage in the raffle record, or in other cases the ticketing server software component might store the details of a shared group license which was available to the operator of the raffle server for these purposes. Any type of server approach which entails either the manual or automated capture of the details of an applicable raffle license with respect to each raffle corresponding to a raffle record in the raffle database, are contemplated within the scope of the present invention.

Where license fees need to be collected in respect of the issuance or maintenance of raffle licenses which are stored in respect of raffle records in the system, the raffle server might also capture or charge the fees required to obtain or maintain those licenses.

The raffle server would in all likelihood transmit the details of the ticket sale upon successful completion of payment and creation of the related data records to the client device of the purchasor. The purchasor can purchase tickets in more than one available raffle of more than one vendor if they wish to do so in certain embodiments, in the same purchase transaction.

### BRIEF DESCRIPTION OF THE DRAWINGS:

To easily identify the discussion of any particular element or act, the most significant digit or digits in a reference number refer to the figure number in which that element is first introduced. The drawings enclosed are:

FIG. 1 is a flow chart demonstrating the steps of one embodiment of the method of the present invention;

FIG. 1A is a flow chart demonstrating the detailed sub steps of ticket sales corresponding to Step in FIG. 1;

FIG. 2 is a schematic diagram of one embodiment of a system architecture in accordance with the present invention;

FIG. 3 is a schematic drawing of one embodiment of the ticketing server of the present invention;

FIG. 4 is a schematic drawing of the key components of one embodiment of a client device in accordance with the present invention;

FIG. 5 is a schematic diagram of one embodiment of a data store and the relevant databases in accordance with the present invention;

FIG. 6 is a block diagram of one embodiment of the ticketing server software of the present invention, showing the different software subroutines therein;

FIG. 7 is a flow chart demonstrating one embodiment of the steps involved in the capture and creation of a purchasor record in the purchasor database, for use in accordance with the remainder of the method of the present invention;

FIG. 8 is a flow chart demonstrating one embodiment of the steps involved in the capture and creation of a raffle record in the raffle database, for use in accordance with the remainder of the method of the present invention;

FIG. 9 is a sample data set from one embodiment of a purchasor database in accordance with the present invention, included for demonstrative purposes of the methodology of the present invention;

FIG. 10 is a sample data set from one embodiment of a raffle database in accordance with the present invention, included for demonstrative purposes of the methodology of the present invention; and

FIG. 11 the second data set from one embodiment of a ticket database in accordance with the present invention, included for demonstrative purposes of the methodology of the present invention.

### DETAILED DESCRIPTION OF THE EMBODIMENTS:

As outlined herein, the present invention comprises a system and method for the self-service fulfilment of ticket sales and raffles or lotteries using a central server capable of communication with the client devices of ticket purchasors. The details of multiple available raffles or lotteries for sale will be presented to a purchasor, based upon comparison of raffle qualification criteria of the purchasor to raffle availability criteria of the raffle. Regulatory and licensing requirements would be facilitated by the system, and license particulars of every lottery a raffle would be stored in the database for use and display to purchasors as required by the regulations in various jurisdictions. The elimination of purpose built ticket sales hardware and/or third-party ticket sales personnel between the server and the purchasor lowers the cost and enhances the convenience of the purchase of tickets in the lotteries or raffles offered for sale.

Lotteries and Raffles:

Many different types of lotteries or raffles could be within the scope of the term “raffle” as used to describe the present invention. The deployment of the method of the present invention in either a lottery or a raffle context will all be understood to be within the scope of the present invention. It will also be understood that in certain cases there are even combination lotteries or raffles which offer more than one type of a bet or a game, and it will be understood that the practice of the method of the present invention will also be understood to be within the scope of the present invention.

Method Overview:

Generally, speaking, the method of the present invention is a method of the self-serve sales of lottery or raffle tickets to the user of a client device from a server with the ticketing software component thereon. Only purchasors who qualified to purchase tickets in a particular licensed lottery or raffle would be permitted the opportunity to do so, and once the time when no for the lottery or raffles completed, the proceeds would be settled from the system and winners selected.

The method of the invention comprises a method of self-serve electronic tickets is to purchasors in a plurality of licensed raffles. The method is practiced by first providing a raffle server which is operatively connected to a communications network for communication with at least one client device. The client device or devices are remote devices capable of communication with the server, and through the user interface of which a purchasor can interact with the server to transact a ticket sale. As outlined in further detail elsewhere herein, the client devices 10 will each be connected by a data network to the ticketing software component of the server 2. All of the client devices 10 might be connected to the same data network or in other embodiments or implementations the server could be operatively connected to more than one data network so that client devices 10 across multiple data networks could, using the server 2 as a bridge between networks, participate in the purchase of raffle and lottery tickets for licensed raffles without the need to be on the same data network.

The raffle server contains a ticketing server software component which is capable of serving and facilitating raffle ticket sales to at least the one client device of the purchasor and is operatively connected to a purchasor database which comprises a plurality of purchasor records. Each purchasor record corresponds to a retail purchasor raffle tickets and includes identifying particulars of the purchasor, along with any raffle qualification criteria of the purchasor which are criteria used to determine the qualification of the purchasor to buy tickets in particular raffles. As well as the purchasor database, the raffle server is also operatively connected to a raffle database which comprises a plurality of raffle records, each of which corresponds to a raffle offered for sale by a vendor and includes ticket price, a defined time period within which ticket sales in the raffle can be made, details of a license applicable to the raffle, and any raffle availability criteria being criteria which must be met by purchasors in order to purchase tickets in the raffle. Finally, there is also operatively connected to the raffle server at ticket database capable of comprising a plurality of ticket records each corresponding to a ticket sold in a raffle and comprising ticket parameters of the tickets sold, a late to the raffle record of the raffle, and a link to the purchasor record of the purchasor. The raffle server is also operatively connected to a payment gateway by which raffle server can process electronic payments for the purchase of tickets.

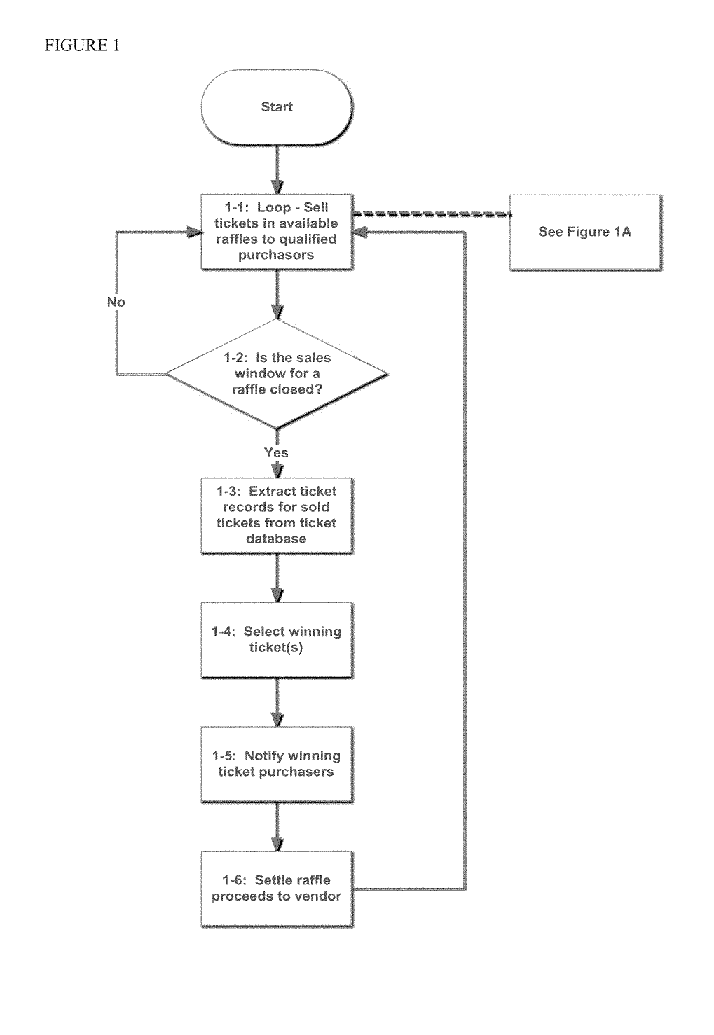

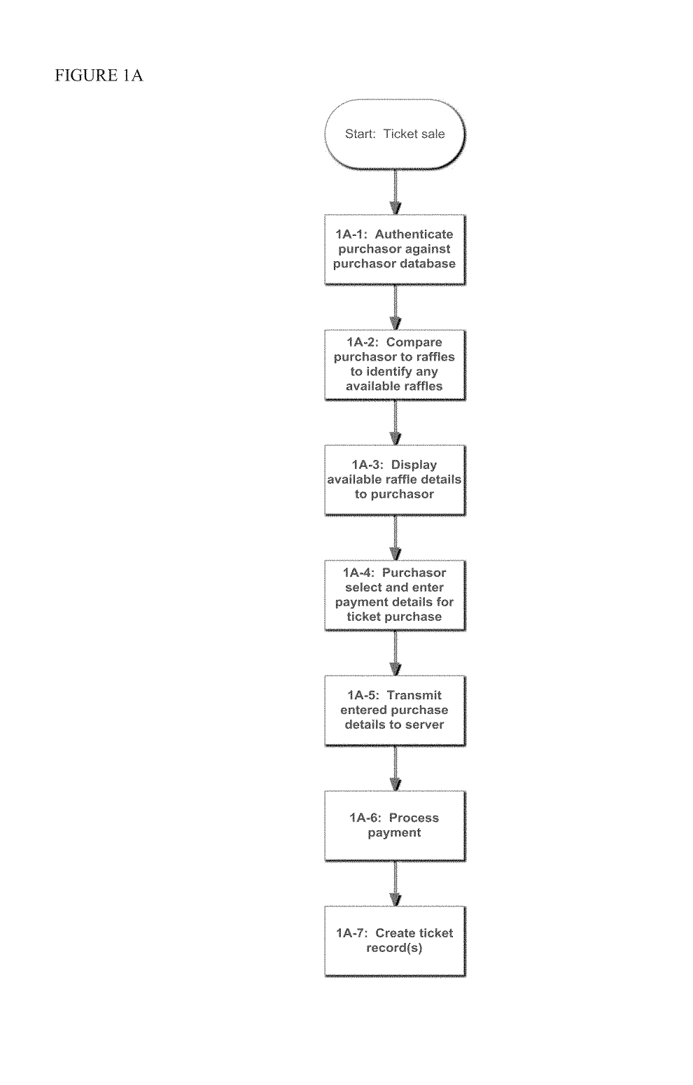

The method of selling the tickets to the purchasers in the raffles configured in the raffle database, as shown in FIG. 1 and FIG. 1A comprises, in respect of each ticket sale, allowing a purchasor who has a purchaser record in the purchasor database to use the user interface is the client device to authenticate themselves to the raffle server, received and reviewed by the user interface of the client devices details of any available raffles, the available raffles being raffles for which the defined time period remains open and for which the raffle qualification criteria of the purchasor satisfied the raffle of the ability criteria of the raffle, and then to purchase at least one ticket and at least one available raffles by the user interface of the client device by selecting at least one available raffle in respect of which at ticket purchases desired, selecting the purchase details the tickets to be purchased and entering electronic payment details in respect of the ticket purchase. It is specifically contemplated that purchasor could buy tickets in more than one available raffle at the same time, in one transaction which will result in the creation of multiple ticket records and the ticket database on the back end of the transaction is completed. The sale of either a single ticket in a single raffle or multiple tickets in one or more raffles in a single purchase transaction are all contemplated within the scope of the invention.

In the embodiment of FIG. 1, the ticket sales loop is shown at Step 1-1. Basically upon accessing the server 2 from a client device 10, a ticket sale transaction could be initiated. The detailed steps involved in a ticket sale transaction are shown in the callow to FIG. 1A.

A purchasor wishing to initiate ticket sale would vindicate themselves against the purchasor database, shown at step 1A-1. This would amount to either the creation and authentication against a new purchasor record in the purchasor database, or logging into the system in a way that you would authenticate yourself against the pre-existing purchasor record.

The purchasor accessing the system would then be presented with a list or display of available raffles unavailable raffle information. A listing of available raffles would be assembled at 1A-2 by the software on the server, comparing the purchasor record of the purchasor and their purchasor qualification criteria to the contents of the raffle database. Raffles with respect to which the sales window had not yet closed and with respect to which the purchasor record indicates compliance with any necessary raffle availability criteria would be available raffles for this purpose.

The available raffles to be presented to the particular purchasor would be displayed to the purchasor via the user interface of the client device, shown at 1A-3. The purchasor could then select the ticket or tickets they wish to purchase in one or more available raffles, and enter payment details for their ticket purchase, shown at 1A-4. The specific interface which could be used to display this information and transact the sale of tickets will be understood to those skilled in the art web interface design and any web interface capable of displaying and facilitating the sale transactions for the sale of tickets in one or more raffles at the same time if that list of available raffles contains more than one raffle, will all be contemplated and understood to be within the scope of the present invention.

Once a purchasor has selected and entered the purchase details for the ticket purchase of a desired also be transmitted, along with a raffle record identifier, purchasor record identifier and electronic payment details of the ticket sale to the raffle server in a purchase transmission. It will be understood that depending upon the nature of the configuration of the software the actual raffle record identifier and purchasor record identifier may not in fact be openly transmitted between the client device 10 insert 2 dependent upon how the software is programmed and the interfaces provided but the information would in any event be transmitted per se to the ticketing server software component within the server 2 to allow for the processing of the ticket sales transaction and the payment.

When the raffle server receives any transmission of purchase details, payment for the tickets represented by the purchase transmission will be processed by the payment gateway, using the transmitted electronic payment details contained within the purchase transmission. Ticket records will be created within the ticket database corresponding to each tickets sold or each ticket sale with respect to each available raffle within that transmission.

The client device within transmit the details of the entered purchase back to the server, as shown at 1A-5, and process payment for the tickets by the payment gateway at 1A-6. Coincidence or following the processing of payment for the tickets, ticket records related to the tickets sold would be created within the ticket database, shown at step 1A-7. The system of the present invention would allow for the sales of multiple tickets to multiple purchasors at the same time in multiple purchase transaction sessions again the development of this type of the system from a technical and multithreaded use perspective will be understood to those skilled in the art and all approaches are contemplated within the scope hereof. Turning back to the overarching method flowchart shown in FIG. 1, there is shown a detection loop which would detect the closing of the sales window of a particular raffle. The ticketing server software component, if no raffle closure detected, would simply continue the availability of ticket sales.

Following the expiry of the defined time period or sales window for raffle, the ticket records corresponding to the expired raffle would be extracted from the ticket database, and at least one winning ticket can be selected therefrom. The details of the at least one winning ticket could be transmitted to the vendor of the raffle and the monetary proceeds of the raffle will be sent to the vendor either electronically or by notification and subsequent provision of the funds thereto—it is specifically contemplated that the system and method of the present invention would be operated as a “service Bureau” rather than by a single ticket vendor and so the settlement of the funds would typically involve the provision of the funds to the vendor of the particular raffle in question.

If the sales window or defined period for sales of tickets in a particular raffle has closed, shown at the positive leg of the decision block 1-2, the ticketing server software component could then conduct the necessary steps to close the raffle. This would consist of the extraction of a subset of ticket records from the ticket database for tickets sold in the closed raffle, shown at 1-3, and selecting at least one winning ticket or the number tickets in respect of the particular raffle therefrom shown at step 1-4. In the embodiment shown, winning ticket purchasors could be notified by the system, shown at 1-5, four and many other embodiments, the details of the winning tickets selected along with the other details of the final ticket sales numbers etc. would simply be provided to the vendor operating raffle by the system when the operator of the system and the vendor can indirectly notify the winning ticket purchasors due course. The system would also then enable the settlement of the raffle proceeds to the vendor, either by electronic transmission or by the generation of a raffle proceeds report net of any operation fees charged by the operator of the system of the present invention etc. which could then allow for the payment of this amount to the vendor this is shown at 1-6.

Each raffle record must contain the details of the applicable license this results in the enforcement of regulatory compliance on the operators of the individual raffles in question. The ticket sales transactions also take place directly between the raffle server and the client devices of the purchaser without any intermediate sales entities.

In many cases the raffle server would be a Web server and the client devices would be internet-enabled devices which could connect to the server via a browser. It will also be understood though that the method can be practiced using purpose built interface or local software for installation on the client devices.

The raffle database could and in all likelihood would contain raffle records corresponding to the raffles of more than one vendor.

As outlined, the system will be used to sell tickets in raffles or lotteries that were in license compliance with local regulations it is explicitly contemplated in the raffles sold through this system what each require a license in the details of the license would be stored within the corresponding raffle record for reporting informational purposes as well as to enforce compliance. The ticketing server software can assign a license to a raffle in the creation of a raffle record, if the ticketing server were operatively connected to a license issued server—that is to say a one-stop approach could be provided to someone wanting to offer a raffle. By setting up the necessary information for the creation of the raffle record, the system of the present invention could procure a license for them and store the details to the appropriate raffle record. Alternatively, where the vendor procures the license for the raffle separately the information can be mainly entered for storage into the raffle record. It is also contemplated that in certain circumstances multiple raffles could share a group license, which will be held and administered by the operator of the server of the present invention—sharing a group license and storage of that information for informational and reporting purposes to the individual raffle records is also contemplated within the scope of the present invention.

Once the ticket sale is completed, the details of the ticket sale can be provided to the client device of the purchasor—for example a screen could be used to show the details of purchased tickets, a receipt could be transmitted by email, text or otherwise etc.

Raffle Qualification Criteria:

One of the key elements of the method of the present invention, being a self-service method of sales of lottery or raffle tickets, is the ability of the method of the present invention to only provide the capability to purchase tickets in a particular raffle to a purchasor who meets particular purchase criteria. Lotteries and raffles are often regulated in their sale and execution and as such sheltering the raffles that are offered to a particular purchasor for sale based on the qualification to see them and to purchase them is one aspect of the method which is important. In order for this aspect of the present invention to work, the purchasor record with respect to a purchasor when it is created will include indications of the raffle qualification criteria which it is desired to capture. For example if particular embodiments of the system of the present invention were to offer for sale tickets in raffles or lotteries that were limited to be sold only to people of a particular age, people residing in a particular jurisdiction, or individuals having other pre-qualifications of the like, details of the qualification of the purchaser's in support of these criteria could be captured when the purchasor record was created and used for comparative purposes at the time of the querying or sale of the ticket. For example, by storing the age of the purchasor in the purchasor record corresponding to, the age of the purchasor can be used as a query or a filter against the raffle records in the raffle database at the time that a purchase query is made, so that only raffles which can be sold to people of that particular age would be shown as available raffles. It will be understood that a number of different types of raffle qualification criteria could be created, to meet virtually any type of a legislative or regulatory regime applicable to lotteries and raffles in a particular jurisdiction. Capturing any type of raffle qualification criteria of the purchasor which could be stored in the purchasor record in the purchasor database, or in a related site card data structure, will be understood to those skilled in the art of database design as well as in the design and execution of regulatory frameworks around raffle and lottery sales and any such type of raffle qualification criteria which can be captured in respect of a particular purchasor or group of purchasors are contemplated within the scope of the present invention.

Raffle Availability Criteria:

With raffle qualification criteria being captured and stored in respect of individual purchasors and the related purchasor records in the purchasor database, the second data which needs to be captured or created in respect of the operation of the system of the present invention to allow for the proper limitation of available raffles is that in addition to the capture of the raffle qualification criteria with respect to one or more purchasors, the system also needs to store one or more raffle availability criteria with respect to at least one of the raffles identified by a raffle record in the raffle database. For example, if an age gateway or threshold is imposed upon the availability of a particular lottery or raffle for sale, in addition to capturing the age of purchasors and their related purchase records for comparison purposes, the threshold age at which the raffle can be made available might be stored as a raffle availability criteria with respect to a particular raffle in the related raffle record. When the legislation applicable to a particular raffle and lottery was such that sales could only be made to purchasors within a particular jurisdiction or who were permanently resident within a particular jurisdiction, the raffle qualification criteria being the address or location of the purchasor might be compared to raffle availability criteria which includes a geo-fence around the jurisdiction from which the purchasor in question is located or resident.

Illustrative Environment and System Architect:

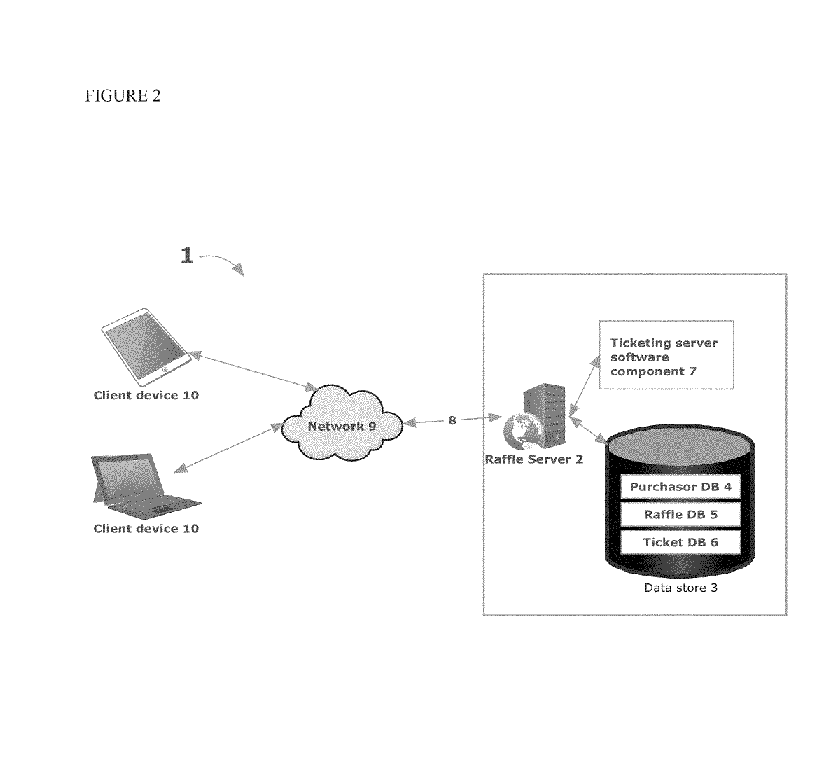

FIG. 2 shows one example of an architecture of a system 1 in accordance with the present invention in which self-service sales of raffle and lottery tickets can be facilitated using client devices 10 interacting with a raffle server 2 to sell and issue tickets to purchasors in accordance with the remainder of the method of the invention. The raffle server 2 might include various software applications to manage aspects of interaction between various components of the system 1, the server 2 or the client devices 10.

The raffle server 2 would include a ticketing server software component 7, responsible for the administration and handling of the method of the present invention. The server 2 would host a data store 3 which consisted of at least three databases, being a purchasor database 4, raffle database 500 ticket database 6. The purchasor database 4 would consist of a plurality of purchasor records each corresponding to a purchasor capable of using the system and method, the raffle database 5 would consist of a plurality of raffle records each of which correspond to a raffle or lottery in which tickets could be sold to qualify purchasers in accordance with the remainder of the method of the present invention, and the ticket database 6 would include the details of tickets sold in accordance with the method.

Client devices 10 would connect to the raffle server 2 via a wide area network 9. The network 9 could be any type of a communications network capable of communication between the client devices 10 and the raffle server 2. It could be a wide area network, a local area network or otherwise. The network 9 as shown could also be any combination of multiple different types of networks such as cable networks, local-area networks, personal area networks, wide area networks, the Internet, wireless networks, ad hoc networks and mesh networks or the like.

The data store 3 which is shown in this Figure demonstrates a consolidated dataset in which all of the databases 43 6 are resident in a single data structure. It will also be understood that in other alternate embodiments of the method and the system of the present invention the raffle server 2 might include or have access to separate data stores for each of the databases 42 6 in freestanding databases or data structures. Different types of data structures which will each accomplish the same overarching method of the present invention will be obvious to those skilled in the art of database design and all are contemplated within the scope hereof.

The architecture shown in FIG. 2 shows the raffle server 2 along with two client devices 10. The client devices 10 which are shown are a tablet computer and a notebook computer. These components are shown purely for demonstrative purposes and it will be understood that many different types of network architectures or system components incentives could be developed which would still accomplish the method outlined herein and all are contemplated within the scope of the present invention.

The server 2 includes or is operatively connected to a payment gateway by which electronic payment transactions can be facilitated, to finalize payment for ticket purchases initiated by purchasor.

Raffle Server:

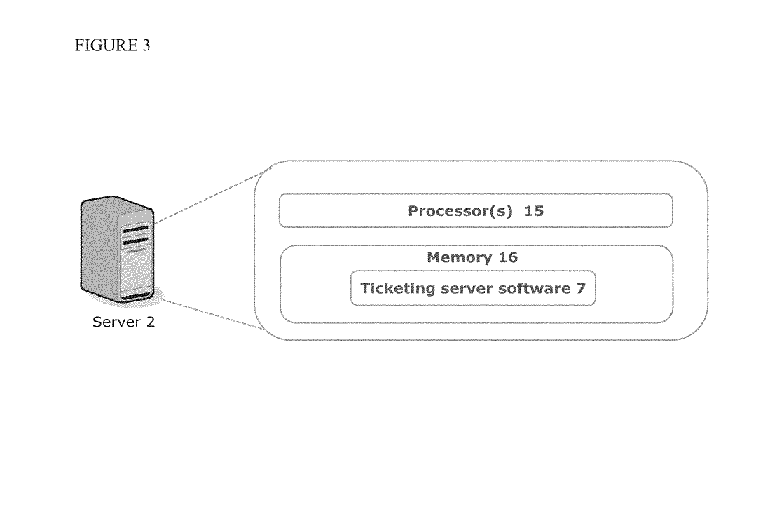

The method of the present invention and the overall architecture would be client/server in nature and would rely on a raffle server 2. The raffle server 2, a sample embodiment of which is shown in FIG. 3, might consist of one or more raffle servers 2—a single server or a server farm approach. The server 2 would comprise one or more processors 15 and memory 16. The memory 16 might contain various software components or a series of processor instructions for use in the method of the present invention or otherwise in the operation of the raffle server 2. Processor instructions corresponding to the ticketing server software component are shown stored within the memory 16 in this Figure.

The server 2 is contemplated to be a Web server, where client devices 10 would use a web browser for interaction therewith. Where a local front app was developed, server 2 might not be a Web server per se but might be a server 2 capable of interaction with the type of an interface on remote client devices. Either such approach is contemplated within the scope hereof.

Server 2 would host or be operatively connected to the data store 3 containing the purchasor database 4, the raffle database 5 and the ticket database 6. In addition to the necessary general operating system instructions and the like, the raffle server 2 would comprise a ticketing server software component 7 which would be responsible for execution of the method of the present invention at the server and, and coordinating the communication with client devices 10 of ticket purchasors. The ticketing server software component 7 might itself act as the interface between the remainder of the hardware and software of the raffle server 2 and the data store with its databases 4 through 6, or the raffle server 2 might alternatively include additional software interfaces to the data store 3 and the databases by which the ticketing server software component 7 and its various subroutines could communicate.

The ticketing server software component 7 would comprise subroutines for the purpose of administering the purchasor database 4, the raffle database 5, the ticket database 6, creating and modifying transactions and records in the data store 3 in the process of interaction with the client devices 10 of purchasors, as well as additional financial or numerical transactions, searches or reporting as might be required. The details of the operation of the ticketing server software component 7 are outlined elsewhere herein.

Client Devices:

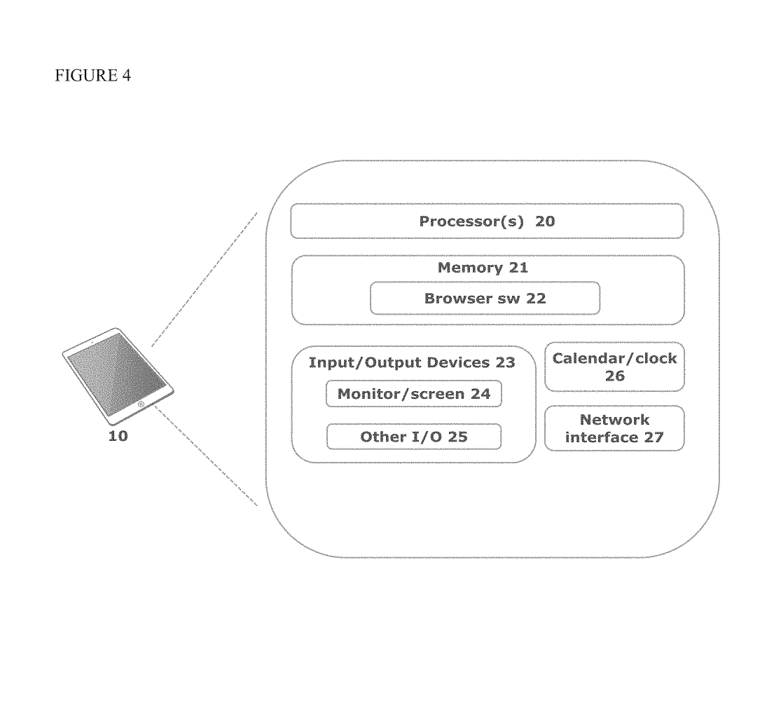

The method of the present invention explicitly contemplates the use of network enabled client devices by ticket purchasors to transact the purchase of tickets in at least one lottery or raffle with a central server 2, using a client device 10. FIG. 4 is a schematic drawing of one client device 10 which could be used in accordance with the remainder of the method of the present invention—a tablet computer is shown. It will be understood by those skilled in the art of client/server application design and the like that any type of a device which could communicate with the server 2 via a network and the related network interface would be within the scope of the present invention. The client device 10 which is shown includes one or more processors 20 and a memory 21. The memory of the client device 10 might include various types of processor instructions either for assistance in the execution of the method of the present invention or for other activities to be undertaken using the client device 10. The memory 21 would include browser software 22 which is used to facilitate interaction between the user, being a ticket purchasor, the client device 10 with the server 2 and the remainder of the method and system of the present invention. Using client/server system programming principles it is contemplated that the browser 22 could likely be fairly thin in nature, back loading as much of the processing as possible to the server and the remainder of the system of the present invention.

The client device 10 includes a network interface 27, by which the client device 10 can communicate via a data network with the server 2. The client device 10 might, as is the case with many portable wireless devices, included GPS or location sensor which could be used to acquire GPS coordinates for the location of the client device 10 or the like, where raffle availability criteria to be applied in the determination of available raffles to be displayed for selection by the user of the device 10 rely in part upon the location of the client device 10. Any type of the location sensor or combination of hardware and software which could yield a location reading could be encompassed herein.

The client device 10 also includes a plurality of input and output devices 23, many of which are required for use of the client device 10. The first input-output device which would be required to the method of the present invention would be a use or display or interface 24, which will allow for the display of information related to available raffles from the raffle database 5 to the user of the client device 10 in the facilitation of the ticket purchase or sale transaction. Some client devices 10 can also include a keyboard or other input output devices 25. While a keyboard would not be necessary some type of interactivity needs to be facilitated the user of the client device 10 and any type of input output devices 23 which can be integrated with the remainder of the client device 10 are contemplated within the scope hereof.

It is explicitly contemplated that the client devices 10 of the present invention would likely be smart phones, tablets, personal computers or the like with the appropriate browser software 22 installed. thereon. The majority of these types of commercially available hardware include all the necessary hardware and software components to participate in the method of the present invention. It will be understood by those skilled in the art of client/server remote application deployment that any type of a computing device which is capable of interaction with the server 2 and any other remainder of the system of the present invention and to interact with the server 2 and the remainder of its associated components by the network are contemplated within the scope of the present invention. The most common approach to the provision of a user interface on the client base 10 for interface the client/server system such as outlined herein would be to provide application front and which could be used on the client device 10 to interact with the server and the system of the present invention. Architecturally and conceptually, the concept of “apps” used on smart phones and other personal devices as a front and to centrally hosted systems is widely known. Where an interface is provided on the client device 10, the user of the client device 10 would interact with the system and server of the present invention by sending and receiving information between the interface at and the server using Internet communication protocol or the like between the client device 10 of the server 2. The specifics of implementing the client/server software system using a website or an at a central bureau and an interface on the client device 2 will be easily understood by those skilled in the art of client/server software design and the method of imitation of a similar approach is contemplated within the scope of the present invention.

Conceptually the use of the local app is the front end or interface to the server of the present invention, programmed using the necessary APIs for the operating system on the client device 10 in question, rather than a browser interface, is at least as likely a possibility as the use of an Internet browser to facilitate the use of the system and method of the present invention. Development of a browser interface or a local app interface as the user interface between the client device 10 and server 2 and the user of the client device 10, and the remainder of the centrally located method of architecture of the present invention will be understood to those skilled in the art client/server database and application design of all such approaches are contemplated within the scope of the present invention.

Communications Network:

It is specifically contemplated that the communications network which would be used for communication between the server 2 and the client devices 10 of ticket purchasers would be the Internet or another publicly available wide-area network. The removal of a requirement for a proprietary or closed communications network between remote ticket sales devices and a central server facilitating the method represents one aspect of the significant enhancement and cost efficiency of the method of the present invention over the prior art practices. The specific protocol for communication between client devices 10 and the server 2 could vary, and differing communications protocols which could be used in this type of an architecture will be understood to those skilled in the art of wide-area computer network design and all such approaches are contemplated within the scope of the present invention.

Data Store:

In the sample architecture diagram shown in FIG. 2, there is shown a data store 3 operatively connected to the remainder of the server 2 which contains the various datasets required for the operation of the method of the present invention. Specifically, the data store 3 as shown contains or hosts the purchaser database 4, the raffle database 5 and the ticket database 6, each of which consist of a plurality of records as outlined in further detail elsewhere herein. The databases 4 through 6 could either each comprise subsets of a consolidated data store 3 such as shown here, or might be represented by individual databases or data stores separately silent within the memory or storage operatively connected to the server 2. Both such approaches will be understood to be within the scope of the present invention.

Any type of the data structure capable of storing the various information for these data subsets 43 6 in respect of purchasers, raffles and tickets which are sold in accordance with the method of the present invention, are contemplated herein. The data store 3 and the databases 43 6 might be resident on the raffle server 2, or might alternatively be resident on or administered remotely within some type of a server farm database environment which was operatively connected for communication with the raffle server 2 and the remainder of the present invention. The data store 3 and related databases might also comprise multiple databases or files from the single database file or structure.

The particular construction or data structure of the data store 3 or individual databases 436 might also depend on the infrastructure design of the remainder of the system of the present tension—again the various aspects of the system, its structure and databases 4 through 6 including those which are infrastructure dependent will be understood to those skilled in the art of relational database and client/server system designed and are all contemplated within the scope of the present invention. It is specifically contemplated that the databases 4 through 6 would most likely comprise SQL database is running on the necessary database server platform, however other approaches or tools and development and its could also be used.

Purchasor Database:

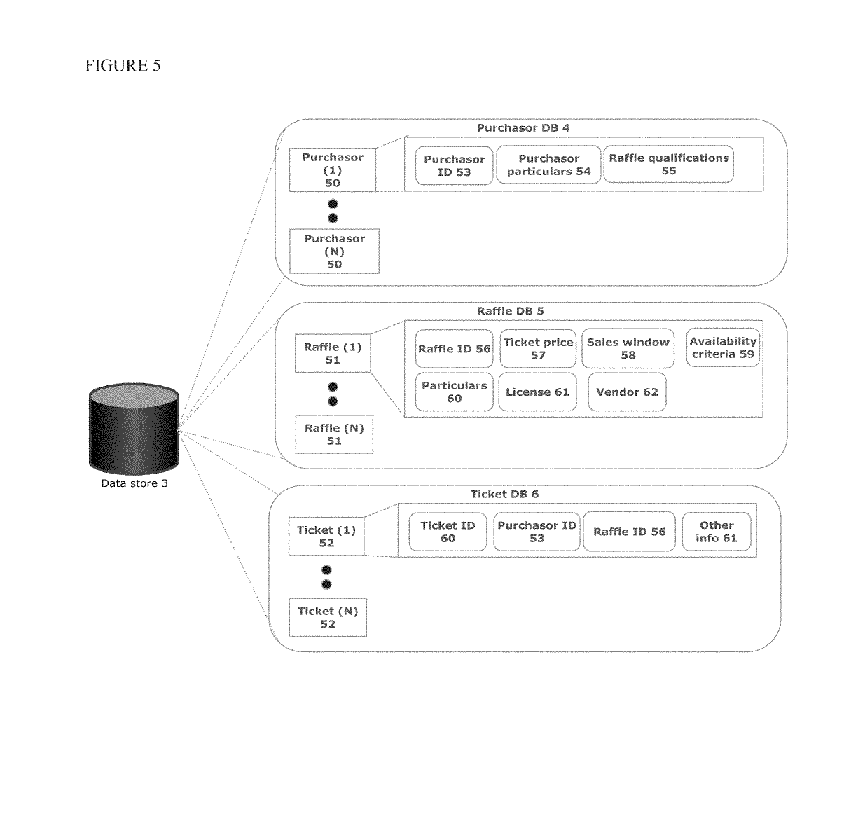

The three datasets 4 through 6 are a key aspect of the practice of the method of the present invention. The first of these is the purchasor database 4, which consists of a plurality of purchasor records 50 which each pertaining to an individual ticket purchasor who wishes to use the system and method of the present invention to purchase lottery or raffle tickets and a raffle being administered in accordance with the remainder of the system. The purchasor records 50 within the purchasor database 4 would effectively each comprise a user profile of a particular purchasor. The number of purchasor records 50 within the database could vary, as is shown in FIG. 5—there is shown 1 through N purchasor records 50, each of which correspond to a ticket purchasor of a particular raffle.

In many embodiments of a purchasor database 4, each purchasor record 50 would include a purchasor identifier 53 or similar database key which is used for identifying the particular purchasor record 50 in operation of the remainder of the software and method of the present invention as well as to link the purchasor record 52 other records in other datasets in the database. It will be understood that in various other flat file embodiments, a purchasor identifier 53 men may not be used each purchasor record 50 would need in some way to be linkable to other elements in system and that all such modifications or approaches are contemplated within the scope of the present invention.

In addition to a purchasor identifier 53 as shown in the embodiment of FIG. 5, purchasor particulars 54 would also be stored in respect of the purchasor in question. This could for example be a username, password, name and address or other particulars of the purchasor that it was desired to capture either for the purpose of the technical operation of the system, or insofar as those persons or particulars 54 might be required for record-keeping purposes in the sale of raffle tickets and particular raffles. For example, in so far as lotteries and raffles are often regulated and required the capture of certain information related to the purchasor of tickets, address information or the like which might be required from the perspective of record-keeping could be captured from the purchasor and stored in the purchasor record 50 as one or more purchasor particulars 54. Any type of purchasor particulars 54 will be understood to be within the scope of the present invention.

In addition to purchasor particulars 54 which might be identifying information or security credentials of the like which could be used to authenticate the purchasor against their corresponding purchasor record 50 in the use of the remainder of the system and method of the present invention, the purchasor record 50 will also include raffle qualification criteria 55 which are captured and stored in respect of the purchasor corresponding to the purchasor record 50 in question. Specifically, and as outlined elsewhere herein, the system of the present invention will only present the option to purchase tickets in raffles for which a particular purchasor is qualified to make the purchase either based on their age, jurisdiction, location or any other type of raffle qualification criteria 55 which might be captured for comparative or qualifying purposes. As will be outlined elsewhere herein, any type of raffle qualifications 55 which could be used to qualify or eliminate from qualification a purchasor in respect of a particular raffle are contemplated within the scope of the present invention.

It will be understood that the purchasor particulars 54 stored within the purchasor record 50 could really be virtually any information that it was desired to retain for record-keeping or method purposes in respect of the purchasor represented by the purchasor record 50. Similarly, the raffle qualification criteria 55 could extend to virtually any number and type of qualifying information for use in determining the availability of certain raffles from the raffle database 5 for the offer of sale of tickets in individual raffles therein.

The purchasor particulars 54 might even include payment details such as credit card details or the like if it was desired to retain those on the system for repeated and rapid use when the purchasor record 50 was used to authenticate a particular purchasor to participate in the purchase of a ticket or tickets in one or more raffles. Some embodiments of the system and method of the present invention may purposely avoid the archival or retention of payment details and might require the purchasor to enter those at the time of purchase of tickets but it will be understood that both such approaches are contemplated within the scope of the present invention.

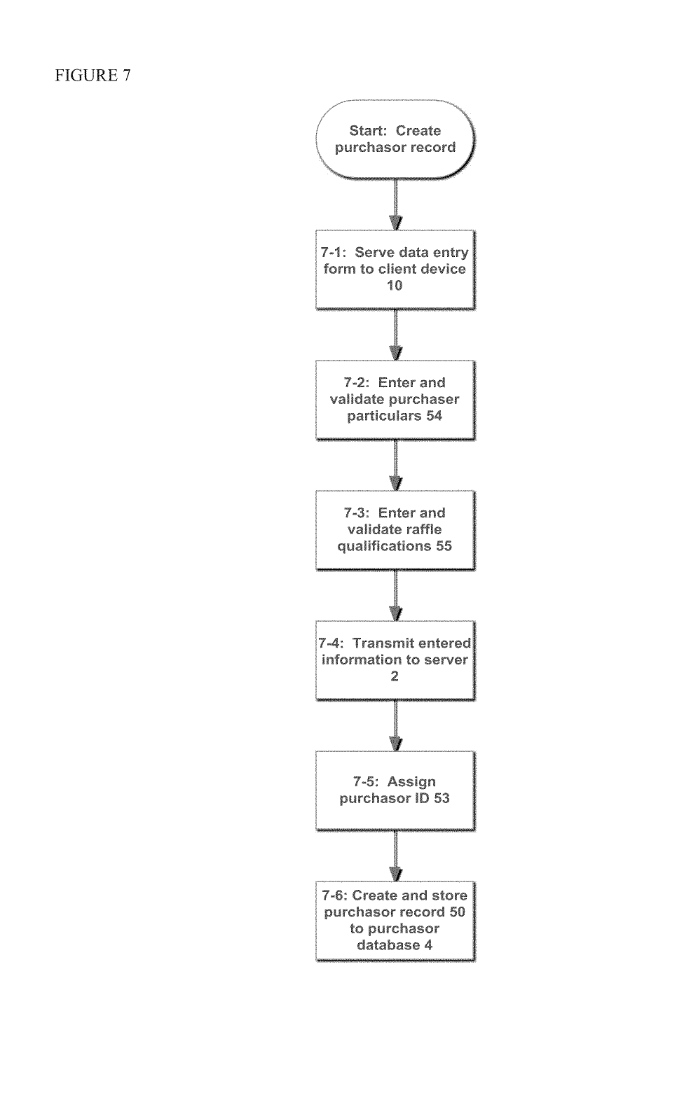

While the primary aspect of the method described in the claims herein is the overarching method of self-serve ticket sales in available raffles to one or more purchasors, the system and method of the present invention might also include facility by which purchasors could actually create the purchasor record 50 corresponding to them—basically allowing to “create a user profile” for a purchasor in advance of the purchase of the first ticket in accordance with the present invention. FIG. 7 is a flowchart demonstrating the steps in one basic embodiment of a method allowing for the creation of a new purchasor record 50 in the purchasor database 4 in accordance with the remainder of the present invention.

As shown in that Figure, at step 7-1 the server 2 would serve a data entry form to the client device 10 of the purchasor. Serving a data entry form to the purchasor via the user interface of their client device 10 could, in the case of the server 2 as a Web server, consists of the actual service of the data entry form to the browser interface of the client device number 10, or where a purpose built local interface app was used, the app on the user interface of the client device 10 could in any event display a data entry form for the entry of purchasor details to the user.

Following the display of the data entry form to the purchasor via their client device 10, the purchasor could enter and validate their purchasor particulars 54, as shown in step 7-2. This could for example include entering the name, address, selecting a password, or entering and validating other purchasor particulars 54 for use in the creation of a purchasor record 50. Validation of the purchasor particulars 54 might in certain cases include testing the contents of the purchasor database 4 to make sure there was not already a pre-existing record for the purchasor etc.—various data validation techniques and approaches will be understood to those skilled in the art and all are contemplated within the scope of the present invention.

In addition to the purchasor particulars 54 which it was desired to capture in respect of the purchasor for storage to the purchasor record 50 created in respect to the purchasor, the data entry interface of the client device 10 would also allow for the entry and/or validation of raffle qualification criteria 55, shown at step 7-3. The raffle qualifications 55 would include whatever qualifying criteria was desired to capture in respect of the purchasor, for subsequent use in the method of the present invention to test and assess the availability of individual raffles for sale to the purchasor at such times they should attempt to initiate a ticket purchase transaction. As outlined above, the raffle qualification criteria 55 could really comprise any number of and type of information which it was desired to capture for this purpose on the system and which could be stored to a purchasor record 50.

Following the entry and validation of purchasor particulars 54 and raffle qualification criteria 55, that entered information would be transmitted to the server 2, shown at step 7-4. The server 2, via the purchasor database administration subroutine of the ticket server software component 7, could assign a purchasor ID 53 or other database key information to the remainder of the information transmitted at 7-4, the assignment of the purchasor ID or other information at the server end being shown in this figure at step 7-5.

The ticket server software component 7 via the appropriate subroutine could then, as shown at 7-6, create and store a purchasor record 50 within the purchasor database 4 based upon the information entered. Once a purchasor has a purchasor record 50 within the purchasor database 4 they will be able to authenticate themselves to a ticket purchase transaction session with the server 2 from their client device 10 and they could continue on with the ticket purchase method outlined in the remainder of this document.

As with the flexibility indicated with the purchasor particulars 54 and the raffle qualification criteria 55, the purchasor ID 53 which could be assigned to a purchasor in the creation of a purchasor record 50 could be a numerical database key or could be any number of other types of system generated information which need to be created, captured or stored in respect of the purchasor in their respective purchasor record 50 for the proper operation of the remainder of the method of the present invention.

The system and method of the present invention could be used in the administration of raffles or lotteries that work for monetary or nonmonetary prizes. For example, in a raffle that had monetary prizes such as a 50-50 or the like, the software on the server could actually calculate in settlement of the raffle proceeds the amount to be dispersed to winners and to the vendor. Alternatively, the calculation and settlement of raffle proceeds in a raffle having nonmonetary prizes could simply involve calculating the total amount of ticket sales less any administration fees and indicating and/or forwarding that amount of funds to the vendor.

FIG. 7 shows one embodiment of a method of the creation of a new purchasor record 50 in the purchasor database 4. It will be understood that there are virtually limitless variations on this overall method in terms of the coding, order of events or other information which might be entered and captured in respect of the purchasor to create a purchasor record 50, and it will be understood that any such approaches contemplated within the scope of the present invention. Similarly, while the embodiment of the purchasor record creation steps shown in FIG. 7 deals with the creation of a purchasor record 50 it will also be understood that an appropriate interface can be provided by which purchasors or administrators can also modify information stored within purchasor records 50 within the purchasor database 4, in addition to creating same.

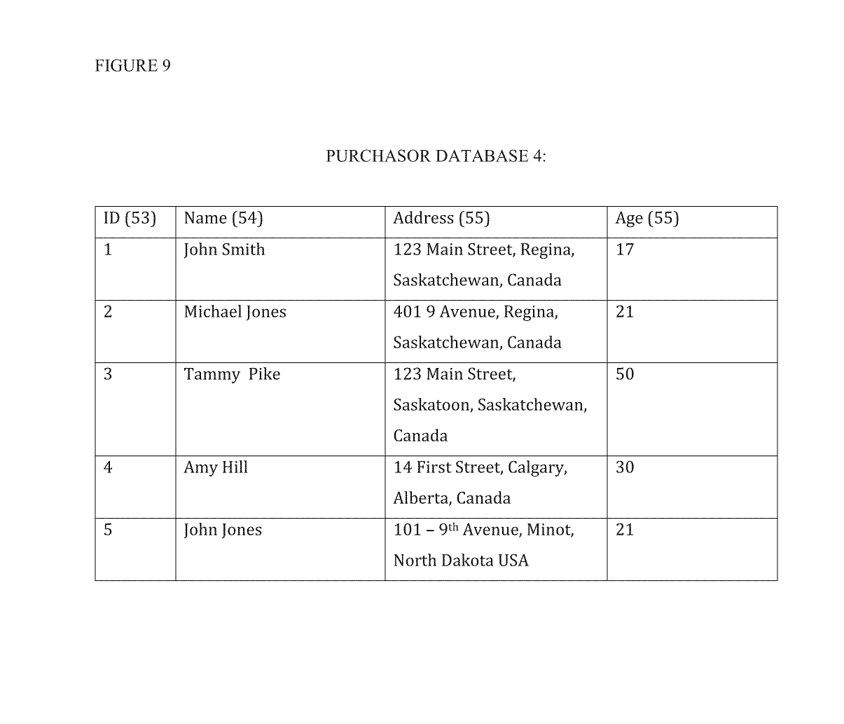

For the sake of demonstration of the flexibility of embodiments of the system and method of the present invention, FIG. 9 demonstrates a set of sample purchasor records 50 identifying five different purchasors who might use the system of the present invention. It will obviously be the case that there would be additional information could be stored in a purchasor record 50 in addition to that shown in this table, but this table demonstrates the basic fields that might be captured for use to demonstrate the operation of embodiments outlined herein. There is shown for each purchasor record and each purchasor, a purchasor ID 53, the name of the purchasor which is a purchasor particular 54, and in this case the address and age of each purchasor are shown. The address and age are each raffle qualification criteria 55. For the sake of demonstration can be seen that the first three purchasors represented by the first three purchasor records 50 are resident in Saskatchewan, the fourth is resident in Alberta, and the fifth purchasor represented by the fifth purchasor record 50 is an American resident. They are of varying ages. As outlined elsewhere herein, the purchasor records 50 could also include payment details or any other number of different types of information for each purchasor.

Raffle Database:

The second key dataset which is required for the practice of the method of the present invention in addition to the purchasor database 4 is the raffle database 5. The raffle database 5 would be a data structure capable of comprising a plurality of raffle records 51, each of which retains the necessary information in respect of a particular raffle in which it is desired to sell tickets. As shown in the embodiment of the raffle database 5 demonstrated in FIG. 4, the raffle database 5 could really consist of any number of raffle records 51, from one through N.

As will also be outlined in further detail below, any number of types of computer-generated or user input information could be stored within a particular raffle record 51 with respect to a raffle in respect of which it was desired to sell tickets in accordance with the remainder of the method of present invention. The key information which is outlined below, which is required to implement basic embodiments of the self-serve ticket sales method of the present invention, can be supplemented with any number of different types of additional information and all such approaches are understood to be contemplated within the scope hereof.

As shown, each raffle record 51 corresponds to a raffle. The first item of information which is represented in the raffle record 50 shown in FIG. 5 is a raffle identifier 56. This is intended to represent any type of the database key which can be used to identify the raffle record 51 and/or to link the particular raffle record 51 to other tables or records in the data store 3 for the purpose of the execution of the method of the present invention.

The next information which would be stored in respect of the raffle in the raffle record 51 is the ticket price 57. The ticket price 57 could be one or more prices depending upon the specific configuration of the raffle record 51 and the particular raffle in question—for example there may be multiple tiers of pricing etc. and the storage of the ticket pricing 57 within the raffle record 51 will include the storage of the necessary information to display and apply the appropriate ticket price 57 to a particular ticket sales transaction session or the like.

In addition to the price of the tickets to be sold in the raffle, the raffle record 51 would also include information related to the defined sales window within which tickets could chronologically be sold in respect of the raffle in question—for example a raffle opens at a particular date and time and closes at another particular date and time. The storage of the sales window information 57 in the raffle record 51 will allow for the determining the chronological openness or availability of particular raffles when determining the availability of raffles via their raffle records 51, in combination with other raffle qualification availability criteria, display available raffle ticket sales to a user or purchasor by the user interface of the client device 10.

Finally, in addition to the ticket price 57 and the defined sales window information 58, the final information which is explicitly contemplated would be stored within a raffle record 51 are raffle availability criteria 59. The raffle availability criteria 59 would be the necessary information captured in respect of the corresponding raffle to allow for the application of availability testing to a particular raffle record 51 based on qualification criteria 55 stored by individual purchasers in their corresponding purchasor record 50. For example if a particular raffle record represented a raffle which can only be sold to users who were resident, within a particular jurisdiction, the resident jurisdiction of the particular purchasor can be captured as a rental qualification 55 in respect of their purchasor record 50, and an appropriate and corresponding rental availability criteria 59 might be an indication of the residence requirements such that the server software component 7 through the appropriate subroutine could at the appropriate time compare those criteria 55 and 59 to determine the availability of that particular raffle and corresponding raffle record for display to the purchasor if they wish to buy a ticket. The number and type of availability criteria 59 which can be captured and stored in particular raffle record 51 or in association with a particular raffle record 51 could really be limitless again, limited only by the legislative requirements of a particular raffle regulation regime and jurisdiction—any type of raffle availability criteria 59 which was desired to be applied to determine the availability and propriety of a particular ticket sales or purchases could be codified away the necessary availability criteria 59 be captured and stored to the raffle record 51 within the database 5.

As with the purchasor database 4 or the ticket database 6, the raffle database 5 could be created in a single data structure or could comprise a plurality of related tables or the like. Design of the raffle database 5, and the other databases 4 and 6, in terms of the data structure could be modified as will be understood to those skilled in the art of database creation and design and any approach which is the part from the intended scope outlined herein is intended to be within the scope of the present invention.

In the case of the purchasor database 4 outlined above, the system and method of the present invention can also provide a user interface by which a vendor of a raffle could create and modify raffle record 51 at the appropriate time in the data store 3, in a self-serve fashion—alternatively an administrator interface could be provided by which only permitted administrators of the system and method of the present invention could create and modify the purchasor records 50 or raffle records 51 therein. It will be understood that both such approaches are contemplated within the scope of the present invention.

Three additional pieces of information are shown in the sample raffle database 5 and related raffle records 51 of the embodiment of FIG. 5. Each raffle record 51 includes other raffle particulars 60, which could be descriptive information which is stored with respect to the raffle for the purpose of the slated purchases in soliciting sales tickets, or other user entered or computer-generated information which is required either for the purpose of marketing and selling tickets in the raffle in question or for other aspects of the execution of the method of the present invention.

Also shown is a license 61. As outlined in the claims herein, one of the key elements of the method of the present invention is that the method will enforce the regulatory compliance of raffles sold in accordance with the system and method herein, by requiring that the details of a valid lottery or raffle license 61 be stored in the raffle record 51. Also shown in the embodiment of FIG. 5 is identification of the vendor 62 of each raffle, which could be used for searching, recording, or display purposes. The license information 61 would be mandatory in accordance with the remainder of the method of the present invention, while the particulars 60 and the vendor identification 62 might be optional fields to be provided as desired by the operator of the system of the time in question.

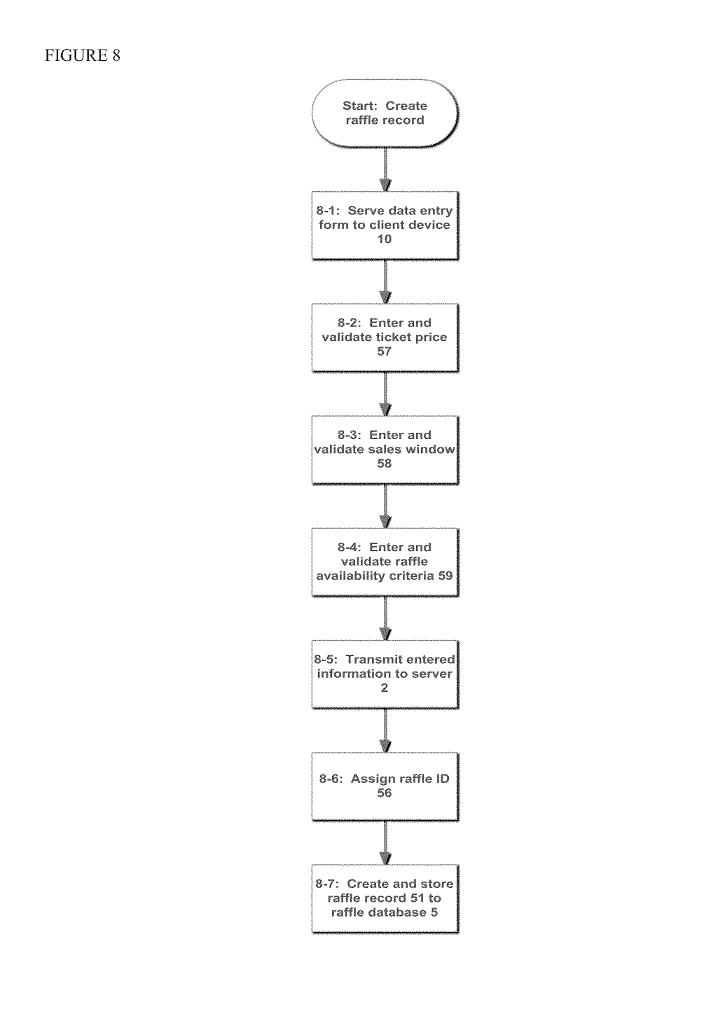

Referring to FIG. 8, there is shown one embodiment of a method for the creation of a raffle record 51 within the raffle database 51. This follows a similar approach to that taken in FIG. 7 outlining the creation of the necessary information and related steps for the creation of a purchasor record 50.

As shown in step 8-1, the first of in this subroutine would be the service of the data entry form from server 2 to the client device 10 of a vendor or administrator—any party who was interested in and capable from a security perspective of creating or editing a raffle record 51. As in the case of the purchasor record routine outlined above, service of the data entry form to the client device 10 could either comprise actually the service of and interactive receipt of information through that form by the server when the server is a Web server and the client device 10 can use a software component which was a browser. Alternatively, if the software component used in the client device 10 was a local interface app, the data entry form or screens can be presented to the user in that fashion and either approach is contemplated within the scope hereof.

In terms of ensuring the necessary information for the creation of the raffle record, the operator of the particular client device 10 would enter validated ticket prices and the necessary ticket pricing framework shown at 57 in step 8-2 as well as the details of the defined sales window 58 within which the raffle can be sold. Entry of that information is shown in step 8-3. It is contemplated that in certain cases the raffle sales window 58 could also be open-ended i.e. sales of the raffle might start at a particular time but could be later cutoff by adding or system imposing a closing time and day onto the sales window 58, if there were regulatory approval or framework allowing for same.

In addition to the ticket price and the sales window information, step 8-4 shows the entry and validation are raffle availability criteria 59. The raffle availability criteria 59 as outlined elsewhere herein are any necessary criteria which can be stored within the raffle record 51 for use in the assessment of the availability of a particular raffle to a particular purchaser as a potential raffle within which they can purchase tickets in accordance with the remainder of the self-service sales method outlined herein.

Following the entry of at least the ticket price 57, sales window information 58 and raffle availability criteria 59, all of that information can be transmitted from the client device 10 to the server 2, which is shown in step 8-5. Following the transmission of that material to the server 2 in whatever appropriate programmed method, a raffle ID 56 can be assigned at the server end, shown at step 8-6 and step 8-7 demonstrates the creation and storage of the raffle record 51 corresponding to the raffle in question within the raffle database 5.

It will be understood to those skilled in the art of web application design and database structure and programming that any number of different approaches can be taken to the population of the raffle database 5 and this method outlined or any number of different embodiments could all be intended within the scope of the present invention and would not depart from the its intended scope thereof.

License Particulars:

As outlined throughout, it is explicitly contemplated that in order to ensure compliance with regulatory requirements for the sale of lotteries and raffles in most jurisdictions, license or permit is required typically to allow for legal sales of raffle tickets in a raffle. The permit or license may establish criteria for who can buy tickets in the raffle—for example residents are age requirements or other information. These criteria could be stored as raffle availability criteria 59 in addition to any of the criteria 59 assigned by the operator of the raffle, in the record. If a raffle record 51 did not include a valid license 61 it is explicitly contemplated that the contents of that raffle record 51 would not be presented to purchasers to the possibility of buying tickets in that raffle.

In certain embodiments of the method of the present invention is contemplated that the server 2 might actually be operatively connected to a permit issuing system or service, such that the server 2 on creation of a raffle record 51 could actually secure the issuance of a license 61 and stored details thereof in the corresponding raffle record 51. In other embodiments, the operator of the raffle being set up in a raffle record 51 would need to procure a license or permit separately and enter the details thereof into the system along with the remainder of the set parameters for the raffle record 51.

It is also contemplated that in certain circumstances it may be legislatively permitted for raffle operators to share a license—for example if a license was not required a basic or shareable license was available for a small pot raffle or the like. It will be understood that the system and method of the present invention could easily accommodate the sharing between raffle records or between raffle vendors of one or more licenses, so long as the appropriate legislative framework was observed in the storage and display that information. Once the license 61 is stored in the raffle records 51, can be displayed on any screens, printed tickets or the like as might be required by law, as well as being used for reporting purposes. In more elaborate embodiments of the present invention in a follow-up reporting is required to the legislative authorities issuing permits, the closure of a raffle for example reporting on total proceeds, that reporting can also be facilitated by the system of the present invention insofar as a report can be generated showing the license identifier 61 and other related information. It will be understood by those skilled in the art of raffle operations as well as in system design such as this that there are many different ways that the capture, storage, use and display of the license information 61 could be implemented without departing from the intended scope of the present invention and all such implementations or approaches are contemplated within the scope of the present invention.

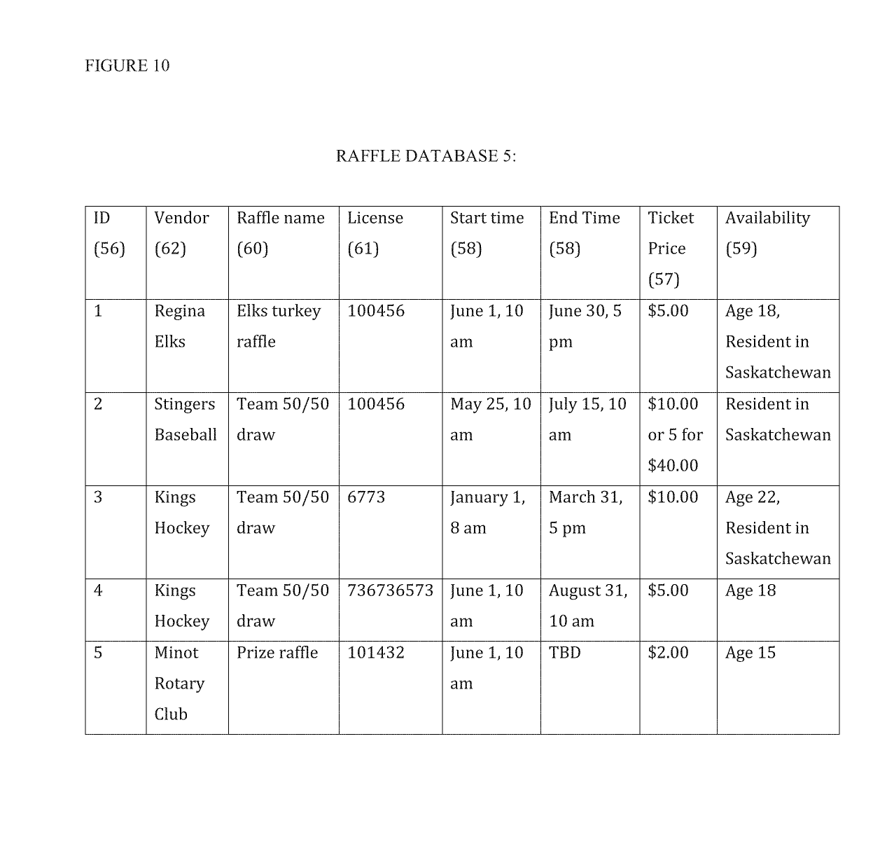

For the sake of demonstration of sonic of the flexibility and anticipated operation of the system and method of the present invention, FIG. 10 includes a sample dataset showing a plurality of hypothetical raffle records 51 created to represent a plurality of raffles which might be offered for sale in accordance with the system of the present invention. Five sample raffle records 51 are shown. In addition to the raffle identifier 56, the ticket price 57 is shown along with the details of the raffle sales window 58. The second raffle record shown demonstrates with respect to the ticket price 57 on multiple tiered pricing structure, which should be stored in the raffle record 51 and applied by the software and system at the time of the sale of tickets to a purchasor. The fifth raffle record shown is intended to demonstrate an open-ended sales window—where the opening or start time 58 for the sales window is included in the record if you want, but the closing time of the raffle is not indicated such that it could remain open ended. It is unlikely that this type of approach would be legislatively permissible but if it were, it could be used in accordance with the remainder of the method of the present invention.

In addition to the ticket price 57 and the sales window details 58, raffle availability criteria 59 are also shown. For the sake of the five records shown in this simple table a number of combinations of age and residency requirements are included in that column of the table and it will be understood that those would be compared to the raffle qualification criteria 55 stored in an individual purchasor record 50 with respect to the purchasor, to determine the visibility or availability of a particular raffle and a sales transaction session were initiated.

Also shown are a raffle name 60 and the vendor name 62 which as outlined elsewhere herein can be optional information also used for display purposes or otherwise required in the administration of the method by the system. Finally, and importantly there is shown license 61 for each raffle record 51. Raffle records 51 without a license 61 therein would be considered in accordance with the remainder of the present invention to be incomplete and those raffle records and their related raffles could not be presented to purchasers for potential ticket purchase. Also shown with respect to the license field 61 in the sample table shown in FIG. 10, the first and second raffle records 51 show the same license identifier—just intended to demonstrate that the system of the present invention could in the appropriate circumstances be contemplated to allow for the sharing of a group or aggregate license granted to the operator of the system of the present invention. Again it is not clear how often that would be legislatively permitted in various jurisdictions licensing or permitting raffles and lotteries but we provide this as a demonstrative point in the flexibility of the system and method in any event.

Also demonstrated is the fact that the system and method of the present invention can be used to administer multiple raffles offered for sale by the same vendor see the third and fourth raffle records 51, which are two 50/50 draws operated by the same hockey team under separate licenses and as shown with separate sales windows 58. Those two particular raffles as shown have different availability criteria 59 applicable thereto so perhaps they gave different prices or there was otherwise some type of different, circumstance applicable to one raffle and the other hut this is intended in any event to demonstrate the possibility that multiple raffles of a single vendor could be administered in the system of the present invention simply by the creation of multiple raffle records 51 corresponding thereto.

Ticket Database:

The third dataset which will be used in the practice of the method of the present invention, in addition to the purchasor database 4 and the raffle database 5 are a plurality of ticket records 52 stored within a ticket database 6. Each ticket sale facilitated in accordance with the present invention will result in the creation of a ticket record 52 within the ticket database 6, storing the details of the ticket or tickets sold in a particular raffle to a particular purchasor.

FIG. 5 shows one embodiment of a basic data structure which could be used for a ticket database 6. There are shown a plurality of ticket records 52, 1 through N.

Each ticket record 52 includes at least a ticket identifier 60, a purchasor identifier 53 and a raffle identifier 56, being a database key or identifier for the ticket record 52 and a link of that particular ticket sale to a purchasor record 50 and a raffle record 51—in the embodiment shown, being a relational database, the record keys in each of the purchasor database 4 of the raffle database 5 could be stored in relation to the ticket record 52 in question to link them together. The ticket record 52 can also include other information 61 related to the particular ticket sale transaction—for example credit card authorization information or other details that would be captured at the time of sale or generated by the system at the time of sale for storage and subsequent use of the settlement and closure of a raffle. Ticket records 52 within the ticket database 6 could be created and maintained by an appropriate subroutine or software component within the ticketing server software 7 within the server 2.

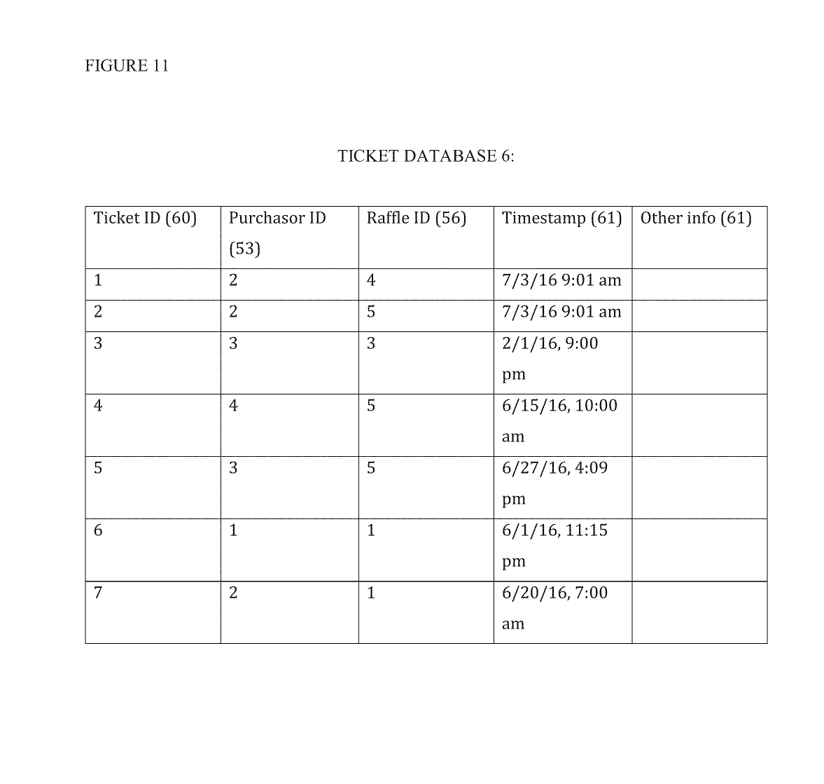

FIG. 11 shows a sample dataset which might represent a plurality of ticket sales in a plurality of ticket records 52 in accordance with a particular period of time and operation of a particular embodiment of the system and method of the present invention. The dataset shown in this Figure demonstrates the sale of tickets to multiple purchasors in a single raffle, in accordance with the application of the raffle qualification criteria 55 and the raffle availability criteria 59. Also, since the for demonstrative purposes, one of the additional information items which should be captured in respect of ticket sales transactions is a timestamp transaction and this is shown at 61. It is specifically contemplated that one of the benefits of the system and method of the present invention is that a purchasor could buy tickets in more than one available raffle in a single sales transaction, resulting in the creation of multiple ticket records related to the tickets purchased in the ticket database 6 with respect to each raffle in question. For the sake of demonstration, the first two ticket records 52 which are shown in the sample dataset FIG. 11 are time stamped at the same time showing the purchase of tickets and to raffles the same purchasor in one transaction. It will be understood that various approaches can be taken to this in terms of offering the ability to purchase tickets and multiple raffles at one time but it is explicitly contemplated that this is one of the business benefits of the system and method here of and any approach which offers this degree of functionality at a business level, regardless of the specific implementation, it is contemplated within the scope of the present invention.

Tick Software:

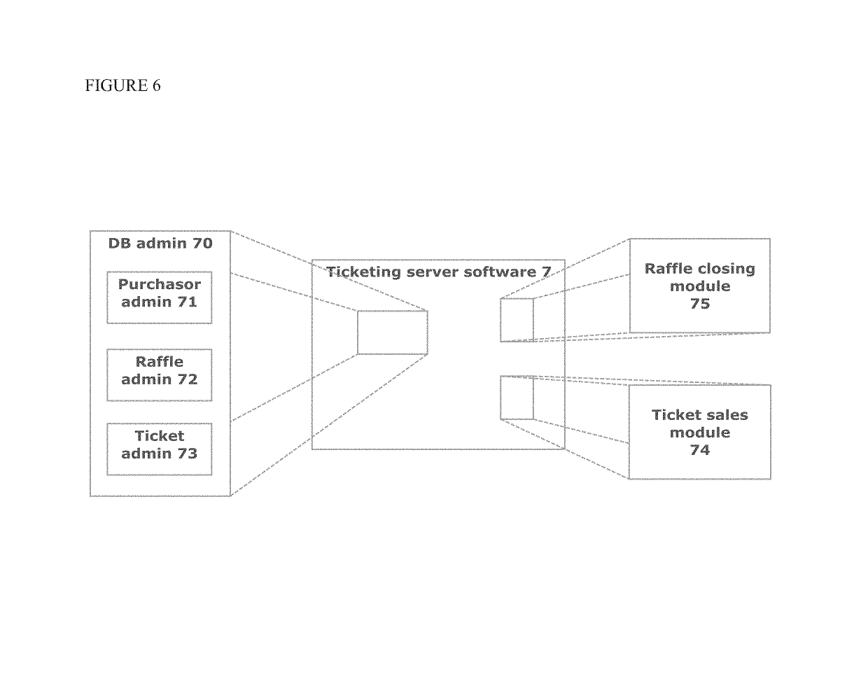

The ticketing server software component 7 resident on or accessible to the server 2 would be key to the performance of the present method. The functions of the ticketing server software component 7 would include the creation and administration of purchasor records, raffle records and ticket records within the data store 3, as well as interaction with ticket purchasers by their client devices in communication sessions with the server. Each function or module of the ticketing server software component 7 could be a freestanding software application of subroutine within a memory or storage and server 2, or alternatively they can all be functions of a consolidated software program—both such approaches are contemplated within the scope of the present invention. FIG. 6 is a block diagram just demonstrating the various software components of the ticketing software server component 7.

Overall, the creation and administration of records in the databases 4 through 6 would be conducted by a database administration module 70. The database administration module 70 could have a number of sub functions or subroutines therein, for the administration of purchasor records, raffle records and ticket records these record administration subroutines for purchasor records, raffle records and ticket records are shown as elements 71, 72 and 73. Many different types of specific database and record administration program approaches are understood to those skilled in the art of database programming and design and again all such approaches are contemplated within the scope of the present invention insofar as software routines for the purpose of administering the contents of the purchasor database 4, raffle database 5 and the ticketing database 6 are all contemplated herein.

Each of the database administration subroutines, 71, 72 and 73 for the purchasor, raffle and ticket databases, which have the necessary process or instructions to allow for the creation and maintenance of records in the purchasor database to allow for, the raffle database 5 in the ticket database 6. Those subroutines might also be called upon by other components of the ticketing server software component 7 to query, extract or report upon the contents of their respective databases and that program will also be understood by those skilled in the art of database programming and design and is all contemplated within the scope here as well.

In addition to the overall database administration module 70 and its related subroutines responsible for interfacing with the data structure of the purchasor database 4, the raffle database 5 and the ticket database six, the processor instructions accessible to the server 2 would also include ministry software instructions to allow for the communication of the server 2 with the client devices 10 via the wide-area network interface.

Also shown in the embodiment of FIG. 6 is a ticket sales module 74, which is contemplated to comprise processor instructions for use by the server 2 in the communication with client devices 10 within the scope of actual ticket sales transactions i.e. authenticating purchasers against the purchasor database 4, selecting available raffles and displaying same to the purchasor, and facilitating the selection, payment and processing of ticket purchases and the creation of ticket records and the ticket database 6 therefrom. The ticket sales module 74 might comprise a number of subroutines for the conduct of different system transactions related to the conduct of the ticket sales session with a purchasor by their client device.

Also shown is a raffle closing module 75, which may or may not be a freestanding subroutine within the ticket server software component 7, but which would accomplish the other related system transactions and reporting etc. which might be required to close out a raffle when the raffle sales window closes i.e. extracting the relevant set of ticket records from the ticket database 6, selecting the winning tickets therefrom and communicating that information along with settlement of raffle proceeds to the vendor of the raffle.

Payment Gateway:

The server 2, either within the ticketing server software component 7 or as a freestanding software or software or hardware combination, would also include or access a payment gateway, through which ticket purchases could be processed. On transmission of the necessary information from the client device 10 of the purchasor to the server 2 resulting in the completion of the ticket sale and the creation of a ticket record 52, that transmission from the client device 10 would include either by way of instant data entry at the user interface of the client device 10, or by reference to archived payment details stored within the purchasor record 50 of the purchasor in question, credit card or other similar payment details which could be used to facilitate a payment transaction to pay for the raffle tickets being sold. Many different types of payment processing approaches will be understood by those skilled in the art of e-commerce system design and really any type of a payment gateway approach which results in the ability of the server 2 and the rest of the software components thereon to facilitate and capture a payment for raffle tickets being sold, in the process of the creation of a ticket record 52 in the ticket database 6 will be understood to be contemplated within the scope of the present invention.

Payment processing could also be done by a third-party payment gateway which is operatively connected to the server 2 i.e. payment particulars could be securely provided to a third-party payment gateway for processing and transmission back of the settlement funds to the operator of the system of the present invention, rather than the need to operate a payment gateway system directly on the server 2. Again either a local or remote payment gateway approach are both contemplated within the scope of the present invention.

Beyond the overall system and method outlined herein, it is also explicitly contemplated that the server 2 with its related databases and software components as otherwise outlined herein is explicitly covered in a freestanding basis by the claims of the application and the assembly of a server which could be used to facilitate the operation of the method of the present invention is intended to be covered in addition to the overarching system and method.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A method of self-serve electronic ticket sales to purchasors in at least one licensed raffle, said method comprising:
a. providing a raffle server operatively connected to a communications network, said raffle server comprising:
i. a ticketing server software component capable of serving and facilitating raffle ticket sales to at least one client device of a purchaser via the communications network;
ii. a purchasor database containing a plurality of purchasor records each corresponding to a retail purchasor of raffle tickets, wherein each purchaser record contains:
1. identifying particulars of the purchasor; and
2. any raffle qualification criteria of the purchasor, being criteria used to determine the qualification of the purchasor to buy tickets in particular raffles;
iii. a raffle database containing a plurality of raffle records each corresponding to a raffle offered for sale by a vendor, wherein each raffle record contains:
1. ticket price information;
2. a defined sales window, being a time period within which tickets in said raffle can be sold;
3. details of a license applicable to the raffle; and
4. any raffle availability criteria, being criteria which must be met by purchasers in order to purchase tickets in said raffle;
iv. a ticket database containing a plurality of ticket records each corresponding to a ticket sold in a raffle, wherein each ticket record contains:
1. a link to the raffle record of the corresponding raffle;
2. a link to the purchasor record of the purchasor; and
3. ticket parameters of the ticket sold;
v. a payment gateway via which said raffle server can process electronic payments for purchase of tickets; and
b. selling tickets in at least one raffle to at least one purchasor by, in respect of each request for a ticket sale:
i. allowing a purchasor having a purchasor record to authenticate themselves to the raffle server, via their client device;
ii. transmitting the details of any available raffles from the server to the client device of the authenticated purchasor, available raffles being any raffles for which:
1. the sales window remains open;
2. the corresponding raffle record contains valid details of a license applicable to the raffle; and
the raffle qualification criteria of the purchasor stored in the purchaser record satisfy the raffle availability criteria of the raffle stored in the raffle record;
iii. allowing the authenticated purchaser to select at least one available raffle in respect of which a ticket purchase is desired via their client device;
iv. capturing electronic payment details and any additional required purchase details for the tickets to be purchased via the client device of the authenticated purchaser; and
v. transmitting the entered purchase details and electronic payment details and the corresponding raffle record identifier to the raffle server in respect of the ticket sale;
vi. processing payment for the tickets sold via the payment gateway, using the transmitted electronic payment details, and creating a ticket record within the ticket database corresponding to each ticket sold in each available raffle; and
c. following the expiry of the sales window for a raffle:
1. extracting the ticket records corresponding to said raffle from the ticket database, being a winning ticket set;
2. selecting at least one winning ticket from the winning ticket set;
3. transmitting the details of the at least one winning ticket to the vendor of said raffle; and
4. settling the monetary proceeds of the raffle to the vendor;
wherein ticket sales transactions take place directly between the raffle server and the client device of the purchasor without any intermediate sales entities.

2. The method of claim 1 wherein the raffle server is a web server, the communications network is the internet, and the at least one client device comprises a web browser software capable of communication with the ticketing server software.

3. The method of claim 1 wherein the raffle database contains raffle records corresponding to raffles of more than one vendor.

4. The method of claim 1 wherein the sale of a ticket further comprises providing details of the ticket sale to the client device of the purchasor.

5. The method of claim 1 wherein a purchasor can purchase tickets in more than one available raffle in the same purchase transaction.

6. The method of claim 5 wherein the tickets purchased are in available raffles operated by more than one vendor.

7. The method of claim 1 wherein the ticketing server software includes the ability to facilitate the creation and maintenance of purchasor records in the purchasor database by a purchasor from their client device.

8. The method of claim 1 wherein the ticketing server software includes the ability to facilitate the creation and maintenance of raffle records in the raffle database by a vendor from their client device.

9. The method of claim 8 wherein the details of the license applicable to the raffle are manually entered into a raffle record.

10. The method of claim 1 wherein the ticketing server software assigns a license to a raffle in the creation of a raffle record by contacting a license issuing server with the details of the raffle and the vendor and receiving the details of an issued license, and storing the details of said license when issued in the raffle record.

11. The method of claim 1 wherein the ticketing server software assigns a license to a raffle in the creation of a raffle record by allowing the raffle record to share a group license held by the operator of the server, the details of which group license are stored to the raffle record.

12. A raffle server for use in a method of self-serve electronic ticket sales to purchasors in at least one licensed raffle, the raffle server being connected to a communications network for communication with at least one client device and comprising:
a. a processor;
b. a memory storing:
i. a ticketing server software component capable of serving and facilitating raffle ticket sales to at least one client device of a purchasor;
ii. a purchasor database containing a plurality of purchasor records each corresponding to a retail purchasor of raffle tickets, wherein each purchaser record contains:
1. identifying particulars of the purchasor; and
2. any raffle qualification criteria of the purchasor, being criteria used to determine the qualification of the purchasor to buy tickets in particular raffles;
iii. a raffle database containing a plurality of raffle records each corresponding to a raffle offered for sale by a vendor, wherein each raffle record contains:
1. ticket price information;
2. a defined sales window, being a time period within which tickets in said raffle can be sold;
3. details of a license applicable to the raffle; and
4. any raffle availability criteria, being criteria which must be met by purchasers in order to purchase tickets in said raffle;
iv. a ticket database containing a plurality of ticket records each corresponding to a ticket sold in a raffle, wherein each ticket record contains:
1. a link to the raffle record of the corresponding raffle;
2. a link to the purchasor record of the purchasor; and
3. ticket parameters of the ticket sold; and
v. a payment gateway via which said raffle server can process electronic payments for purchase of tickets;
wherein in respect of each ticket sale to a purchasor with a client device, the ticketing server software will facilitate the steps of:
a) allowing a purchasor having a purchasor record to authenticate themselves to the raffle server, via their client device;
b) transmitting the details of any available raffles from the server to the client device of the authenticated purchasor, available raffles being any raffles for which:
i. the sales window remains open;
ii. the corresponding raffle record contains valid details of a license applicable to the raffle; and
iii. the raffle qualification criteria of the purchasor stored in the purchaser record satisfy the raffle availability criteria of the raffle stored in the raffle record;
c) allowing the authenticated purchaser to select at least one available raffle in respect of which a ticket purchase is desired via their client device;
d) capturing electronic payment details and any additional required purchase details for the tickets to be purchased via the client device of the authenticated purchasor; and
e) transmitting the entered purchase details and electronic payment details and the corresponding raffle record identifier to the raffle server in respect of the ticket sale;
f) processing payment for the tickets sold via the payment gateway, using the transmitted electronic payment details, and creating a ticket record within the ticket database corresponding to each ticket sold in each available raffle; and
and wherein following the expiry of the sales window for a raffle the server will facilitate the steps of:
a. extracting the ticket records corresponding to said raffle from the ticket database, being a winning ticket set;
b. selecting at least one winning ticket from the winning ticket set;
c. transmitting the details of the at least one winning ticket to the vendor of said raffle; and
d. settling the monetary proceeds of the raffle to the vendor;
wherein ticket sales transactions take place directly between the server and the client device of the purchasor without any intermediate sales entities.

13. The raffle server of claim 12 wherein the raffle server is a web server and the communications network is the internet.

14. The raffle server of claim 12 wherein the raffle database contains raffle records corresponding to raffles of more than one vendor.

15. The raffle server of claim 12 wherein the ticketing server software assigns a license to a raffle in the creation of a raffle record by contacting a license issuing server with the details of the raffle and the vendor and receiving the details of an issued license, and storing the details of the issue license in the raffle record.

16. The raffle server of claim 14 wherein the ticketing server software collects a license fee from the vendor of the raffle in advance of the commencement of ticket sales.

17. The raffle server of claim 12 wherein the ticketing server software assigns a license to a raffle in the creation of a raffle record by allowing the raffle record and related raffle to share a group license held by the operator of the raffle server.

18. The raffle server of claim 12 wherein the sale of a ticket further comprises transmitting details of the ticket sale to the client device of the purchasor.

19. The raffle server of claim 12 wherein a purchasor can purchase tickets in more than one available raffle in the same purchase transaction.

20. The raffle server of claim 19 wherein the tickets purchased are in available raffles operated by more than one vendor.

21. The raffle server of claim 12 wherein the ticketing server software includes the ability to facilitate the creation and maintenance of purchasor records in the purchasor database by a purchasor from their client device.

22. The raffle server of claim 12 wherein the ticketing server software includes the ability to facilitate the creation and maintenance of raffle records in the raffle database by a vendor from their client device.
